(19) United States
(12) Patent Application Publication
(10) Pub. No.: US 2021/0025124 A1
(43) Pub. Date: Jan. 28, 2021

(54) APPARATUS AND METHODS FOR REINFORCING TELECOMMUNICATIONS TOWERS

(71) Applicant: TOWER ENGINEERING SOLUTIONS, LLC, Las Vegas, NV (US)

(72) Inventors: Hanming YOU, Irving, TX (US); Robert SEMAAN, Aventura, FL (US)

(21) Appl. No.: 17/045,566

(22) PCT Filed: Apr. 6, 2018
(86) PCT No.: PCT/US2018/026512

§ 371 Date: Oct. 6, 2020

(51) Int. Cl. E02D 27/42; E02D 27/50; E02D 5/80

(52) U.S. Cl. CPC E02D 27/42; E02D 27/50; F05B 2240/912; E02D 2600/30; E02D 5/80

(57) ABSTRACT

A reinforcing apparatus for a telecommunications tower having a foundation at least partially embedded in the ground includes: a plurality of reinforcing bars at least partially embedded in the foundation; a transition member extending outward from the foundation; a joint connector connecting the plurality of reinforcing bars to a first end of the transition member; and an anchor attached to a second end of the transition member. The anchor is embedded in the ground. Methods of reinforcing a telecommunications tower are also described.

### FIELD OF THE DISCLOSURE

The present disclosure relates to an apparatus and methods for reinforcing telecommunications towers, and in particular to an apparatus and methods for reinforcing the foundation of telecommunications towers.

### BACKGROUND OF THE DISCLOSURE

The wireless telecommunications industry has been growing steadily for a number of years. Due at least in part to changes in design standard codes and the additional equipment installed on telecommunications towers (e.g., monopoles), many tower structures have inadequate tower/pole support in their upper structure and their foundation. The foundation is a critical structural component. It provides support to the entire tower/pole structure. Accordingly, a strong foundation helps to ensure the stability and strength of the tower/pole structure.

Typical types of foundation bases in telecommunications towers are pier foundations, mat foundations and spread footings. A foundation can fail in a variety of ways, including but not limited to inadequacy of uplift resistance, axial capacity, overturning moment resistance, rebar strength, and concrete strength. Traditional solutions to reinforce the foundation include adding new piers, piles and/or helical anchors to the foundation, adding concrete blocks, enlarging the size of the mat foundation, or replacing the existing foundations. Due to onsite existing shelters and other equipment around the tower/pole, however, these approaches may not be practicable. In addition, conventional reinforcing methods are typically very expensive.

These and other shortcomings are addressed by aspects of the present disclosure.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a top perspective view of a portion of a reinforcing apparatus according to aspects of the disclosure.

FIG. 2 is a top view of a plurality of reinforcing apparatus according to aspects of the disclosure.

FIG. 3 is a side view of an anchor, second environmental cover and a portion of a transition member according to aspects of the disclosure.

FIG. 4 is a top view of a reinforcing apparatus according to aspects of the disclosure.

FIG. 5 is a top view of a portion of a reinforcing apparatus according to aspects of the disclosure.

FIG. 6 is a side view of the portion of the reinforcing apparatus shown in FIG. 5.

FIG. 7 is a process diagram describing a method for reinforcing a telecommunications tower according to aspects of the disclosure.

### SUMMARY

Aspects of the disclosure relate to a reinforcing apparatus for a telecommunications tower, the telecommunications tower including a foundation at least partially embedded in the ground, the reinforcing apparatus including:

a plurality of reinforcing bars at least partially embedded in the foundation;

a transition member extending outward from the foundation;

a joint connector connecting the plurality of reinforcing bars to a first end of the transition member; and

an anchor attached to a second end of the transition member. The anchor is embedded in the ground.

Aspects of the disclosure further relate to a method for reinforcing a telecommunications tower, the telecommunications tower including a foundation at least partially embedded in the ground, the method including:

at least partially embedding a plurality of reinforcing bars into the foundation;

embedding an anchor in the ground at a distance from the foundation;

attaching a first end of a transition member to the plurality of reinforcing bars with a joint connector; and

attaching a second end of the transition member to the anchor.

### DETAILED DESCRIPTION

The present disclosure can be understood more readily by reference to the following detailed description of the disclosure and the Examples included therein. In various aspects, the present disclosure relates to a reinforcing apparatus for a telecommunications tower, the telecommunications tower including a foundation at least partially embedded in the ground. The reinforcing apparatus includes a plurality of reinforcing bars at least partially embedded in the foundation, a transition member extending outward from the foundation, a joint connector connecting the plurality of reinforcing bars to a first end of the transition member, and an anchor attached to a second end of the transition member. The anchor is embedded in the ground, and when connected to the foundation by way of the transition member, provides lateral resistance in the ground (soil) and provides structural support and/or strength to the foundation and telecommunications tower. Methods for reinforcing the foundation of a telecommunications tower are also described.

Before the present articles, systems, devices, and/or methods are disclosed and described, it is to be understood that they are not limited to specific synthetic methods unless otherwise specified, or to particular components unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

### Definitions

It is also to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to a structure including “a transition member” includes structures having two or more transition members.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless otherwise stated to the contrary herein, all test standards are the most recent standard in effect at the time of filing this application.

### Reinforcing Apparatus for a Telecommunications Tower

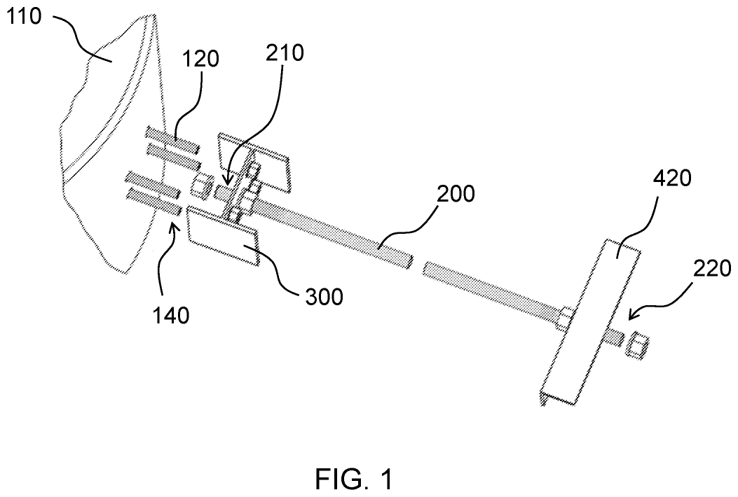

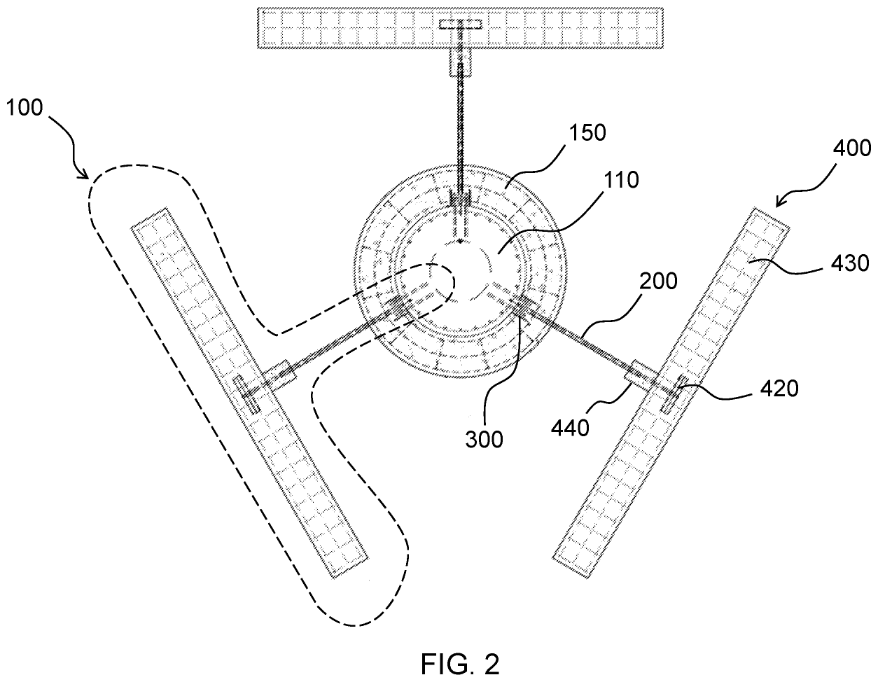

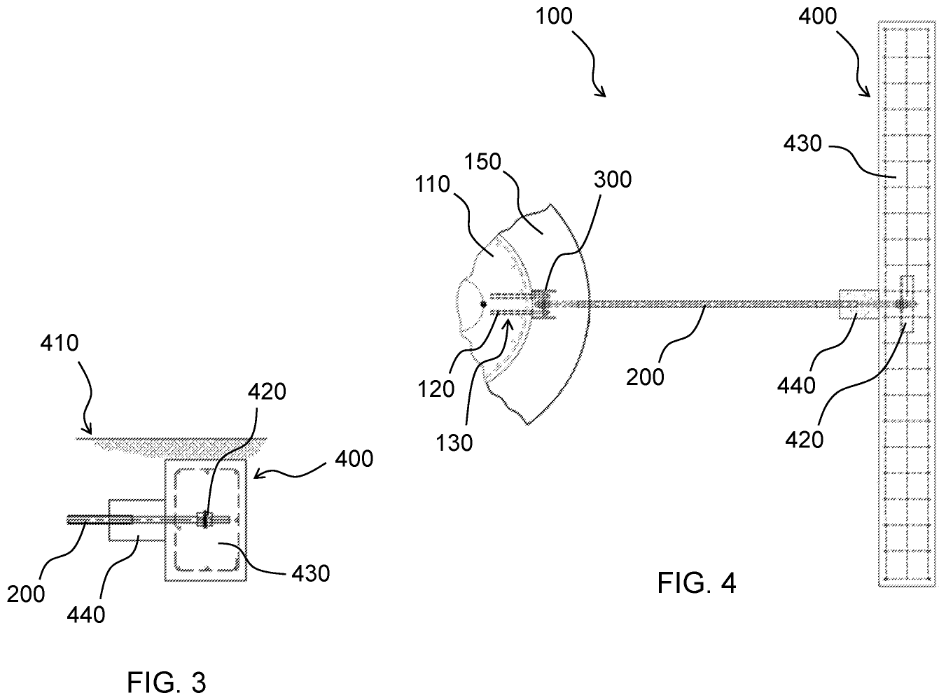

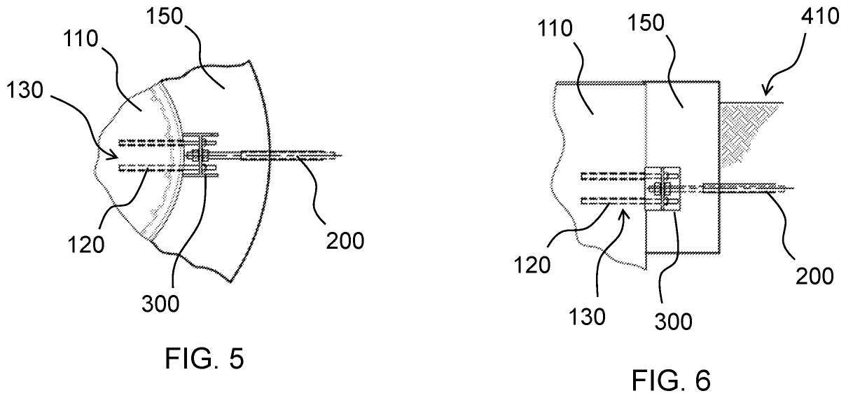

With reference to FIGS. 1-6, aspects of the disclosure relate to a reinforcing apparatus 100 for a telecommunications tower (not shown), the telecommunications tower including a foundation 110 at least partially embedded in the ground. The reinforcing apparatus 100 includes a plurality of reinforcing bars 120 at least partially embedded in the foundation 110, a transition member 200 extending outward from the foundation 110, a joint connector 300 connecting the plurality of reinforcing bars 120 to a first end 210 of the transition member 200, and an anchor 400 attached to a second end 220 of the transition member 200. The anchor 400 is embedded in the ground 410, and when connected to the foundation 110 by way of the transition member 200, provides lateral resistance in the ground 410 (soil) and provides structural support and/or strength to the foundation 110 and telecommunications tower.

In some aspects the anchor 400 includes a bearing plate 420 and a support member 430. A second end 220 of the transition member 200 may be attached to the bearing plate 420, and the bearing plate 420 is retained within the support member 430. The support member 430 may include, but is not limited to, one or more of a concrete deadman, a sheet pile, a concrete block, or a metal beam. The bearing plate 420 can include, but is not limited to, a metal plate or angle. The bearing plate 420, when used, transfers forces from the transition member 200 to the support member 430. When embedded in the ground 410, and when connected to the foundation 110 by way of the transition member 200 and the bearing plate 420, support member 430 provides lateral resistance in the ground 410 (soil) and provides structural support and/or strength to the foundation 110 and telecommunications tower.

The anchor 400 is embedded in the ground 410 at a distance from the foundation. The distance may be variable and can depend on factors such as, but not limited to, the soil properties (design parameters), anticipated applied forces to the anchor, and the location of other equipment proximate the foundation 110. In some aspects, the anchor 400 is installed at a distance of from about 10 feet to about 75 feet from the foundation 110. In particular aspects the anchor 400 is installed at a distance of from about 15 feet to about 50 feet from the foundation. The anchor 400 may be installed at any desirable depth in the ground 410, and may be installed so that the transition member 200 is angled downward towards the anchor 400 from the foundation 110, upward towards the anchor 400 from the foundation 110, or so that the transition member 200 is substantially horizontal with respect to the anchor 400 and the foundation 110. In certain aspects, the anchor 400 is installed at a depth of from about 2 feet to about 8 feet. In particular aspects, the anchor 400 is installed at a depth of from about 3 feet to about 5 feet.

The transition member 200 may include, but is not limited to, a tension bar, rebar, a concrete beam, a metal beam (e.g., an I-beam), a threaded rod, a wire, a cable, a steel bar, an angle, a flat bar, a solid rod, or a channel. In some aspects the transition member 200 is a tension member; in further aspects the transition member 200 is a tension and compression member. The transition member 200 can be installed horizontally or at an angle to the ground 410/grade surface, as described in further detail below. The transition member 200 transfers tension and/or compression forces from the foundation 110 to the anchor 400. In some aspects the transition member 200 includes a protective coating applied to exposed surfaces thereof, and can include any coating that prevents exposure of metallic parts to moisture. In a particular aspect the coating is a polymeric coating such as the XTRA coating that is available from LINE-X®.

The plurality of reinforcing bars 120 at least partially embedded in the foundation 110 may include, but are not limited to, a dowel bar, rebar, threaded bar, or a metal rod. A first portion 130 of each reinforcing bar 120 may be at least partially embedded in the foundation and bonded to the foundation 110 with epoxy or another bonding material. A second portion 140 of each reinforcing bar 120 extends outward from the foundation 110.

In some aspects a first environmental cover 150 surrounds the second portion 140 of the plurality of reinforcing bars 120, the joint connector 300 and the first end 210 of the transition member 200. The first environmental cover 150 protects the second portion 140 of the plurality of reinforcing bars 120, the joint connector 300 and the first end 210 of the transition member 200 from exposure to moisture and corrosion resulting from exposure to moisture. In some aspects the first environmental cover 150 is a concrete block that surrounds the foundation 110. In further aspects the first environmental cover 150 is a protective coating applied to exposed surfaces of the second portion of the plurality of reinforcing bars, the joint connector and the first end of the transition member. The protective coating can be any coating that prevents exposure of metallic parts to moisture. The protective coating may include any of the coating materials described herein.

In certain aspects the reinforcing apparatus 100 further includes a second environmental cover 440 that surrounds a portion of the transition member 200 in contact with the anchor 400. The second environmental cover 440 protects the portion of the transition member 200 in contact with the anchor 400 from exposure to moisture and corrosion resulting from exposure to moisture. The second environmental cover 440 may include, but is not limited to, a concrete enclosure. In certain aspects the second environmental cover 440 is a protective coating applied to exposed surfaces of the portion of the transition member in contact with the anchor. The protective coating may include any of the coating materials described herein.

Aspects of the disclosure further relate to a telecommunications tower (not shown) including a plurality of the reinforcing apparatus 100 described herein. Thus, for example, in some aspects 2, 3, 4 or even more of the reinforcing apparatus 100 may be installed around the foundation 110 of the telecommunications tower so that forces acting on the telecommunications tower/foundation 110 can be distributed to one or more of the reinforcing apparatus 100. In particular aspects the telecommunications tower is a monopole.

### Methods for Reinforcing the Foundation of a Telecommunications Tower

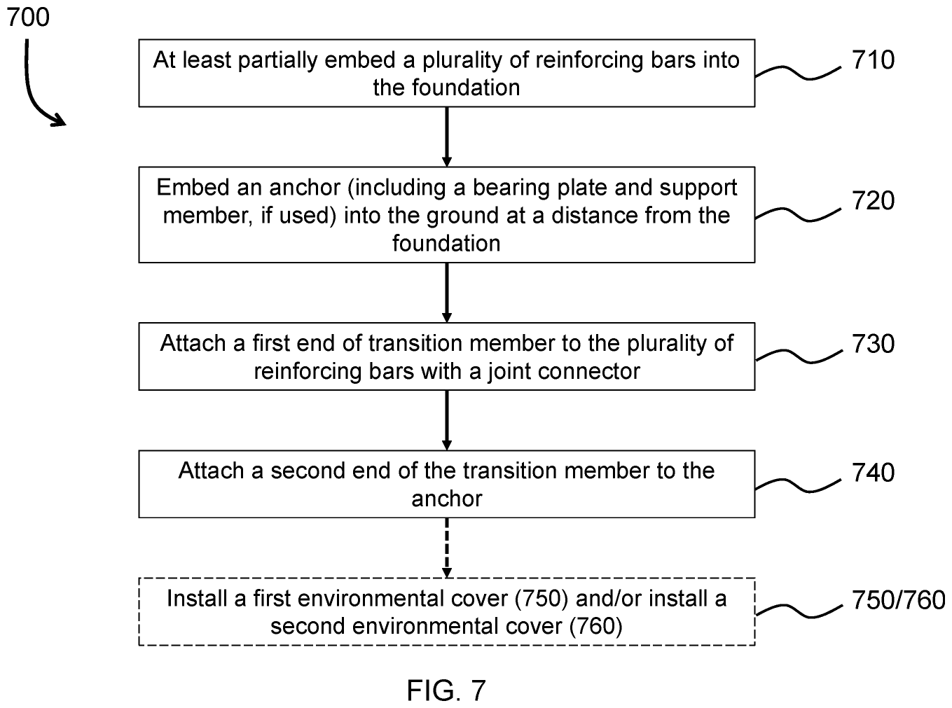

With reference to FIG. 7 and FIGS. 1-6, aspects of the disclosure further relate to a method 700 for reinforcing a telecommunications tower. The telecommunications tower includes a foundation 110 at least partially embedded in the ground 410. The method includes:

at least partially embedding a plurality of reinforcing bars 120 into the foundation 110 at step 710;

embedding an anchor 400 in the ground 410 at a distance from the foundation 110 at step 720;

attaching a first end 210 of a transition member 200 to the plurality of reinforcing bars 120 with a joint connector 300 at step 730; and

attaching a second end 220 of the transition member 200 to the anchor 400 at step 740.

In some aspects the anchor 400 includes a bearing plate 420 and a support member 430, as described herein. The bearing plate 420 and support member 430, if included, may be configured as described herein and may include any of the materials described herein.

The transition member 200 may include, but is not limited to, a tension bar, rebar, a concrete beam, a metal beam (e.g., an I-beam), a threaded rod, a wire, a cable, a steel bar, an angle, a flat bar, a solid rod, or a channel. In some aspects the transition member 200 is a tension member; in further aspects the transition member 200 is a tension and compression member. The transition member 200 can be installed horizontally or at an angle to the ground 410/grade surface, as described in further detail below. The transition member 200 transfers tension and/or compression forces from the foundation 110 to the anchor 400. In some aspects the transition member 200 includes a protective coating applied to exposed surfaces thereof, and can include any coating that prevents exposure of metallic parts to moisture. The protective coating may include any of the coating materials described herein.

As noted, the anchor 400 is embedded in the ground 410 at a distance from the foundation. The distance may be variable and can depend on factors such as, but not limited to, the soil properties (design parameters), anticipated applied forces to the anchor, and the location of other equipment proximate the foundation 110. In some aspects, the anchor 400 is installed at a distance of from about 10 feet to about 75 feet from the foundation 110. In particular aspects the anchor 400 is installed at a distance of from about 15 feet to about 50 feet from the foundation. The anchor 400 may be installed at any desirable depth in the ground 410, and may be installed so that the transition member 200 is angled downward towards the anchor 400 from the foundation 110, upward towards the anchor 400 from the foundation 110, or so that the transition member 200 is substantially horizontal with respect to the anchor 400 and the foundation 110. In certain aspects, the anchor 400 is installed at a depth of from about 2 feet to about 8 feet. In particular aspects, the anchor 400 is installed at a depth of from about 3 feet to about 5 feet.

The plurality of reinforcing bars 120 at least partially embedded in the foundation 110 may include, but are not limited to, a dowel bar, rebar, threaded bar, or a metal rod. A first portion 130 of each reinforcing bar 120 may be at least partially embedded in the foundation and bonded to the foundation 110 with epoxy or another bonding material. A second portion 140 of each reinforcing bar 120 extends outward from the foundation 110.

In some aspects the method further includes, at step 750, surrounding the second portion 140 of the plurality of reinforcing bars 120, the joint connector 300 and the first end 210 of the transition member 200 with a first environmental cover 150 as described herein. The first environmental cover 150 protects the second portion 140 of the plurality of reinforcing bars 120, the joint connector 300 and the first end 210 of the transition member 200 from exposure to moisture and corrosion resulting from exposure to moisture. The first environmental cover 150 may include, but is not limited to, a concrete block that surrounds the foundation 110. In further aspects the first environmental cover 150 is a protective coating applied to exposed surfaces of the second portion of the plurality of reinforcing bars, the joint connector and the first end of the transition member. The protective coating can be any coating that prevents exposure of metallic parts to moisture. The protective coating may include any of the coating materials described herein.

In further aspects the method further includes, at step 760, surrounding a portion of the transition member 200 in contact with the anchor 400 with a second environmental cover 440. The second environmental cover 440 protects the portion of the transition member 200 in contact with the anchor 400 from exposure to moisture and corrosion resulting from exposure to moisture. The second environmental cover 440 may include, but is not limited to, a concrete enclosure. In certain aspects the second environmental cover 440 is a protective coating applied to exposed surfaces of the portion of the transition member in contact with the anchor. The protective coating may include any of the coating materials described herein.

In some aspects the telecommunications tower to which the method 700 is applied is a monopole.

The reinforcing apparatus 100 described herein can be used to prevent or minimize instability or movement of a foundation 110 of a telecommunications tower. If a conventional foundation is inadequate because of soil capacities and/or excessive loading on the telecommunications tower, the foundation could settle deeper into the ground, move up, move from side-to-side and/or rotate about its vertical axis. With one or more reinforcing apparatus 100 installed, however, the point of rotation of the foundation 110 will shift upward when moment and/or lateral forces are applied. In some aspects the rotation point moves to a point that is around 25% to 45% of the length of the foundation, depending on its depth, soil parameters and applied loads. The reinforcing apparatus 100 of the present disclosure transfers forces from the foundation 110 to the anchor 400 by way of the transition member 200. Soil lateral resistance acting from the side of the anchor 400 will support horizontal forces from the foundation 110. When the horizontal resistance is strong enough, the rotation point of the foundation will shift to at or near the point where the transition member 200 is attached to the foundation 110. Further, if the transition member 200 is installed at a downward angle into the ground, the anchor 400 can provide both uplift and lateral resistance to the foundation 110.

The reinforcing apparatus of the present disclosure thus provides one or more of the following features:
It provides a safe and permanent solution on existing foundations.
All installation work may be performed at a short distance (e.g., from within a few inches to several feet) from the surface of the ground.
The anchor can be installed away from the foundation if there is insufficient space near the foundation.
If there are shelters or other equipment proximate the foundation, the transition member can be installed under the shelter foundation or equipment base foundation.
Large equipment and/or tools are not required in the installation of the reinforcing apparatus.
Additional reinforcing capacities—if desired—can be achieved by installing concrete block or sheet piles on each side of the anchor.

Various combinations of elements of this disclosure are encompassed by this disclosure, e.g., combinations of elements from dependent claims that depend upon the same independent claim.

### Aspects of the Disclosure

In various aspects, the present disclosure pertains to and includes at least the following aspects.

Aspect 1. A reinforcing apparatus for a telecommunications tower, the telecommunications tower comprising a foundation at least partially embedded in the ground, comprising:

a plurality of reinforcing bars at least partially embedded in the foundation;

a transition member extending outward from the foundation;

a joint connector connecting the plurality of reinforcing bars to a first end of the transition member; and

an anchor attached to a second end of the transition member, wherein the anchor is embedded in the ground.

Aspect 2. The reinforcing apparatus according to Aspect 1, wherein the anchor comprises a bearing plate and a support member, the second end of the transition member is attached to the bearing plate, and the bearing plate is retained within the support member.

Aspect 3. The reinforcing apparatus according to Aspect 2, wherein the support member comprises one or more of a concrete deadman, a sheet pile, a concrete block, or a metal beam.

Aspect 4. The reinforcing apparatus according to any of Aspects 1 to 3, wherein the transition member comprises a tension bar, rebar, a concrete beam, a metal beam, a threaded rod, a wire, a cable, a steel bar, an angle, a flat bar, a solid rod, or a channel.

Aspect 5. The reinforcing apparatus according to any of Aspects 1 to 4, wherein each of the plurality of reinforcing bars comprise a dowel bar, rebar, threaded bar, or a metal rod.

Aspect 6. The reinforcing apparatus according to any of Aspects 1 to 5, wherein each of the plurality of reinforcing bars at least partially embedded in the foundation comprise a first portion that is embedded in the foundation and a second portion that extends outward from the foundation, and the apparatus further comprises a first environmental cover that surrounds the second portion of the plurality of reinforcing bars, the joint connector and the first end of the transition member, wherein the first environmental cover protects the second portion of the plurality of reinforcing bars, the joint connector and the first end of the transition member from exposure to moisture.

Aspect 7. The reinforcing apparatus according to Aspect 6, wherein the first environmental cover comprises a concrete block that surrounds the foundation or a protective coating applied to exposed surfaces of the second portion of the plurality of reinforcing bars, the joint connector and the first end of the transition member.

Aspect 8. The reinforcing apparatus according to any of Aspects 1 to 7, further comprising a second environmental cover that surrounds a portion of the transition member in contact with the anchor, wherein the second environmental cover protects the portion of the transition member in contact with the anchor from exposure to moisture.

Aspect 9. The reinforcing apparatus according to Aspect 8, wherein the second environmental cover comprises a concrete enclosure or a protective coating applied to exposed surfaces of the portion of the transition member in contact with the anchor.

Aspect 10. A telecommunications tower comprising a plurality of the reinforcing apparatus according to any of Aspects 1 to 9.

Aspect 11. The telecommunications tower according to Aspect 10, wherein the telecommunications tower comprises a monopole.

Aspect 12. A method for reinforcing a telecommunications tower, the telecommunications tower comprising a foundation at least partially embedded in the ground, the method comprising:

at least partially embedding a plurality of reinforcing bars into the foundation;

embedding an anchor in the ground at a distance from the foundation;

attaching a first end of a transition member to the plurality of reinforcing bars with a joint connector; and

attaching a second end of the transition member to the anchor.

Aspect 13. The method according to Aspect 12, wherein the anchor comprises a bearing plate and a support member, the second end of the transition member is attached to the bearing plate, and the bearing plate is retained within the support member.

Aspect 14. The method according to Aspect 13, wherein the support member comprises one or more of a concrete deadman, a sheet pile, a concrete block, or a metal beam.

Aspect 15. The method according to any of Aspects 12 to 14, wherein the transition member comprises a tension bar, rebar, a concrete beam, a metal beam, a threaded rod, a wire, a cable, a steel bar, an angle, a flat bar, a solid rod, or a channel.

Aspect 16. The method according to any of Aspects 12 to 15, wherein each of the plurality of reinforcing bars comprise a dowel bar, rebar, threaded bar, or a metal rod.

Aspect 17. The method according to any of Aspects 12 to 16, wherein each of the plurality of reinforcing bars at least partially embedded in the foundation comprise a first portion that is embedded in the foundation and a second portion that extends outward from the foundation, and the method further comprises surrounding the second portion of the plurality of reinforcing bars, the joint connector and the first end of the transition member with a first environmental cover, wherein the first environmental cover protects the second portion of the plurality of reinforcing bars, the joint connector and the first end of the transition member from exposure to moisture.

Aspect 18. The method according to Aspect 17, wherein the first environmental cover comprises a concrete block that surrounds the foundation or a protective coating applied to exposed surfaces of the second portion of the plurality of reinforcing bars, the joint connector and the first end of the transition member.

Aspect 19. The method according to any of Aspects 12 to 18, further comprising surrounding a portion of the transition member in contact with the anchor with a second environmental cover, wherein the second environmental cover protects the portion of the transition member in contact with the anchor from exposure to moisture.

Aspect 20. The method according to any of Aspects 12 to 19, wherein the second environmental cover comprises a concrete enclosure or a protective coating applied to exposed surfaces of the portion of the transition member in contact with the anchor.

Aspect 21. The method according to any of Aspects 12 to 20, wherein the telecommunications tower comprises a monopole.

### Examples

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

A foundation of a telecommunications tower has a depth of 22 feet and a diameter of 6.5 feet. Three reinforcing apparatus according to aspects described herein are installed around the foundation 120 degrees apart from one another. Each of the anchors includes a concrete support member that is 20 feet long, 1.5 feet wide and 3 feet high. The anchors are installed 12 feet from the edge of the foundation and are connected to the foundation with a steel rebar transition member having a yield strength of 60 kilopound force per square inch (ksi).

Without the three reinforcing apparatus installed, the foundation has an exemplary overturning resistance of 2265 kips-ft (kilo pounds force-foot), which is below a designed factor moment of 2509 kips-ft. This is unacceptable. With the three reinforcing apparatus installed, however, the foundation has a calculated moment capacity of 2541 kips-ft as compared to a designed factor moment of 2509 kips-ft. Thus, the moment capacity of the modified foundation including the three reinforcing apparatus exceeds the designed values. The moment capacity of 2541 kips-ft is calculated based on the transition member 200 being a tension member; if the transition member 200 is a compression and tension member, this moment capacity will be increased to 2805 kips-ft.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A reinforcing apparatus for a telecommunications tower, the telecommunications tower comprising a foundation at least partially embedded in the ground, comprising:
a plurality of reinforcing bars at least partially embedded in the foundation;
a transition member extending outward from the foundation;
a joint connector connecting the plurality of reinforcing bars to a first end of the transition member; and
an anchor attached to a second end of the transition member, wherein the anchor is embedded in the ground.

2. The reinforcing apparatus according to claim 1, wherein the anchor comprises a bearing plate and a support member, the second end of the transition member is attached to the bearing plate, and the bearing plate is retained within the support member.

3. The reinforcing apparatus according to claim 2, wherein the support member comprises one or more of a concrete deadman, a sheet pile, a concrete block, or a metal beam.

4. The reinforcing apparatus according to claim 1, wherein the transition member comprises a tension bar, rebar, a concrete beam, a metal beam, a threaded rod, a wire, a cable, a steel bar, an angle, a flat bar, a solid rod, or a channel.

5. The reinforcing apparatus according to claim 1, wherein each of the plurality of reinforcing bars comprise a dowel bar, rebar, threaded bar, or a metal rod.

6. The reinforcing apparatus according to claim 1, wherein each of the plurality of reinforcing bars at least partially embedded in the foundation comprise a first portion that is embedded in the foundation and a second portion that extends outward from the foundation, and the apparatus further comprises a first environmental cover that surrounds the second portion of the plurality of reinforcing bars, the joint connector and the first end of the transition member, wherein the first environmental cover protects the second portion of the plurality of reinforcing bars, the joint connector and the first end of the transition member from exposure to moisture.

7. The reinforcing apparatus according to claim 6, wherein the first environmental cover comprises a concrete block that surrounds the foundation or a protective coating applied to exposed surfaces of the second portion of the plurality of reinforcing bars, the joint connector and the first end of the transition member.

8. The reinforcing apparatus according to claim 1, further comprising a second environmental cover that surrounds a portion of the transition member in contact with the anchor, wherein the second environmental cover protects the portion of the transition member in contact with the anchor from exposure to moisture.

9. The reinforcing apparatus according to claim 8, wherein the second environmental cover comprises a concrete enclosure or a protective coating applied to exposed surfaces of the portion of the transition member in contact with the anchor.

10. A telecommunications tower comprising a plurality of the reinforcing apparatus according to claim 1.

11. The telecommunications tower according to claim 10, wherein the telecommunications tower comprises a monopole.

12. A method for reinforcing a telecommunications tower, the telecommunications tower comprising a foundation at least partially embedded in the ground, the method comprising:
at least partially embedding a plurality of reinforcing bars into the foundation;
embedding an anchor in the ground at a distance from the foundation;
attaching a first end of a transition member to the plurality of reinforcing bars with a joint connector; and
attaching a second end of the transition member to the anchor.

13. The method according to claim 12, wherein the anchor comprises a bearing plate and a support member, the second end of the transition member is attached to the bearing plate, and the bearing plate is retained within the support member.

14. The method according to claim 13, wherein the support member comprises one or more of a concrete deadman, a sheet pile, a concrete block, or a metal beam.

15. The method according to claim 12, wherein the transition member comprises a tension bar, rebar, a concrete beam, a metal beam, a threaded rod, a wire, a cable, a steel bar, an angle, a flat bar, a solid rod, or a channel.

16. The method according to claim 12, wherein each of the plurality of reinforcing bars comprise a dowel bar, rebar, threaded bar, or a metal rod.

17. The method according to claim 12, wherein each of the plurality of reinforcing bars at least partially embedded in the foundation comprise a first portion that is embedded in the foundation and a second portion that extends outward from the foundation, and the method further comprises surrounding the second portion of the plurality of reinforcing bars, the joint connector and the first end of the transition member with a first environmental cover, wherein the first environmental cover protects the second portion of the plurality of reinforcing bars, the joint connector and the first end of the transition member from exposure to moisture.

18. The method according to claim 17, wherein the first environmental cover comprises a concrete block that surrounds the foundation or a protective coating applied to exposed surfaces of the second portion of the plurality of reinforcing bars, the joint connector and the first end of the transition member.

19. The method according to claim 12, further comprising surrounding a portion of the transition member in contact with the anchor with a second environmental cover, wherein the second environmental cover protects the portion of the transition member in contact with the anchor from exposure to moisture.

20. The method according to claim 19, wherein the second environmental cover comprises a concrete enclosure or a protective coating applied to exposed surfaces of the portion of the transition member in contact with the anchor.

21. The method according to claim 12, wherein the telecommunications tower comprises a monopole.
